(19) United States
(12) Patent Application Publication
(10) Pub. No.: US 2003/0079382 A1
(43) Pub. Date: May 1, 2003

(54) Apparatus for accenting vehicle license plates

(76) Inventor: Susanne Arens, Colorado Springs, CO (US)

Correspondence Address: Kent A. Lembke, Esq., Hogan & Hartson, LLP, Suite 1500, 1200 17th Street, Denver, CO, 80202, US

(21) Appl. No.: 10/165,484

(22) Filed: Jun. 6, 2002

Related U.S. Application Data
(63) Continuation-in-part of application No. 10/055,166, filed on Oct. 29, 2001.

(51) Int. Cl. G09F 7/00

(52) U.S. Cl. 40/210

(57) ABSTRACT

An accent bar for personalizing a license plate while securing the license plate within the mounting bracket of a vehicle. The accent bar includes an elongate structural member with mounting loops or holes for mounting the accent bar on the top, the bottom, or both portions of the vehicle mounting bracket. The elongate structural member only extends across the top or bottom or both of the license plate and does not extend all around the plate as with frames. An accent or display element is provided in the bar, either integrally or separately with the elongate member, to provide a graphical or textual display. When two accent bars are utilized, the accent or display elements may combine to form a single accent or display feature. The materials, sizes, and shapes of the accent bar and the accent elements may be varied to create numerous vehicle accents and messages.

### CROSS REFERENCE TO RELATED PATENT APPLICATIONS

This application is a continuation-in-part of Application No. 10/055,166, filed Oct. 29, 2001, for “License Plate Frame and Accent Bar Having Customizing Logos,” the disclosure of which is herein specifically incorporated by this reference.

### BACKGROUND OF THE INVENTION

1. Field of the Invention

The present invention relates in general to vehicle license plate mounting, framing, and decorating, and more particularly to, an apparatus for accenting the top, bottom, or both top and bottom of a vehicle license plate without the use of a full frame.

2. Relevant Background

It has long been desirable to customize license plate frames for vehicles with metal or plastic frames around and/or over the periphery of the license plates. Each frame is fabricated with a particular set format, which may include designs, blank portions, logos, and/or trademarks. The blank portions are provided on many frames so they may be engraved with custom messages or provide smooth surfaces for letters and logos having adhesive backings. No method has been available for a stock frame to be customized with specializing logos and trademarks so that it looks like a unitary frame. Instead, dealers of license plate frames have to stock a multiplicity of frames to meet the varied demands of their customers.

Many vehicles are designed with a very limited space for mounting a license plate. Add-on brackets for holding displays for text or graphics near the license plates are often not useful with these vehicles. Additionally, obstructions near the license plate mounting bracket, such as protruding features on a vehicle bumper, may affect an upper portion of the mounting bracket in some vehicles and may affect a lower portion of the mounting bracket in other vehicles. Hence, it has been difficult to come up with a single wrap-around frame or add-on display assembly that is useful with all or nearly all vehicles. This difficulty has limited vehicle operators to accenting or personalizing their vehicles with bumper stickers or stock license plate frames

Hence, there remains a need for an apparatus for use in securely mounting license plates within mounting brackets that can also be used to accent or personalize the vehicle. Preferably, such apparatus would be simple to manufacture and install to control costs and increase its utility while also being flexible in design to allow accenting of nearly all vehicle makes and models by providing a method of displaying textual phrases, graphical designs, and combinations of text and graphics.

### SUMMARY OF THE INVENTION

The present invention addresses the above needs and problems by presenting an apparatus for securing license plates on vehicles while also providing accenting for the license plate or near the plate. In one embodiment, this apparatus includes a license plate accent bar that can be mounted on typical license plate mounting brackets located on the front and/or back of vehicles with the license plate positioned between the bracket and the license plate accent bar. The accent bar includes an elongate member or bar with a pair of mounting loops or holes therein that are spaced apart and size to facilitate mounting with standard licenses plate mounting brackets, e.g., a similarly sized loop or hole to accept a screw or bolt used with the bracket. The accent bar may be mounted on the top or upper portion of the license plate mounting bracket, on the bottom or lower portion of the license plate mounting bracket, or on the top and bottom portions of the bracket concurrently. The accent bars do not wrap around the edges or sides of the license plate but only partially cover the top or bottom edges of the license plate, which reduces material costs and allows displays or accent materials to be provided with nearly every vehicle make regardless of mounting bracket and surrounding vehicle structure design.

In preferred embodiments, the accent bars provide a unique and effective way to accent vehicles and particularly, the license plate area of the vehicle. In these embodiments, the accent bars include an accent element that may be designed with nearly any shape or size. For example, the accent element may take the shape of animals, such as snakes, eagles, bears, lions, and the like, of graphic designs such as combinations of geometric shapes, of forms that are of national, regional, or local interest, of insignia, logos, or of designs of interest to sports enthusiasts, and of many other shapes. The accent element may be a standalone shape place only on the top or bottom of the license plate mounting bracket. In other embodiments, a first accent element may be provided on an upper accent bar and a second accent element may be provided on a lower accent bar mounted on the upper and lower portions of the license plate mounting bracket, respectively. In these embodiments, the first and second accent elements may combine to create a single, but spaced apart, visual effect (such as a top and bottom of a graphical design, e.g., an upper portion of a skull and shoulder or bones for the first accent element and a lower portion of the skull and skeletal fingers in a second accent element, or a first and second portion of a textual phrase in the first and second accent elements). While the accent elements may be manufactured separately and later attached to the elongate member to form an accent bar, the accent element often is formed in a manner to include or become the elongate member and to include the mounting loops or holes for allowing license plate mounting brackets to be passed through to fasten the accent bar against the license plate, thereby securely fastening the plate to the bracket and vehicle. In this manner, the support function of the accent bar is integrally and efficiently, in space and materials, combined with desirable graphic and/or text display functions without the need for bulky or complicated add on display brackets or the need for a wrap-around frame.

Other features and advantages of the present invention will become apparent from the following detailed description, taken in conjunction with the accompanying drawings, which illustrate, by way of example, the principles of the invention.

### BRIEF DESCRIPTION OF THE DRAWINGS

FIG. 1 is a front elevation view of an accent bar for the top or bottom of a license plate;

FIG. 2 is a front view of another embodiment of an accent bar according to the invention in which display or accent functionality has been combined with structural functionality;

FIG. 3 is a view similar to FIG. 2 showing another embodiment of an accent bar with a different accent element and being configured for mounting on the lower portion of a license plate;

FIG. 4 is a front view of an accent assembly that uses an upper and a lower accent bar to provide an upper and lower display area for a combined graphic message;

FIG. 5 is a view similar to FIG. 4 of another accent assembly including upper and lower accent bars with textual accent elements that combine to display a text message;

FIG. 6 is a top, front, right side perspective view of an accent bar as the customizing logo is about to be installed;

FIG. 7 is a right side elevation view of FIG. 6;

FIG. 8 is another front elevation view of the accent bar of FIG. 1;

FIG. 9 is a top, front, right side perspective view of the accent bar of FIG. 1;

FIG. 10 is a top, front, right side perspective view of the accent bar of FIG. 1; and

FIG. 11 is a top, front, right side perspective view similar to FIG. 10 prior to installation of the accent element.

### DETAILED DESCRIPTION OF THE PREFERRED EMBODIMENTS

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

Referring initially to FIG. 1, a front elevation view of a license plate frame having a customizing logo and trademark in accordance with the present invention is shown in accordance with the present invention, generally designated 20. The frame 20 has top and bottom cross members 22 and 24, respectively, right and left sides 26 and 28, respectively, mounting loops 30, 32, 34, and 36 for mounting the frame 20 in front of a vehicle license plate frame, a logo 38, and a trademark 40.

FIG. 2 is a front elevation view of an accent bar 50 for the top and/or bottom of a license plate. Significantly, instead of going completely around a license plate, the accent bar 50 includes an elongate structural member 51 that generally will extend substantially parallel to the upper and lower edges of a license plate when the bar 50 and license are mounted within a license plate mounting bracket. In practice, the accent bar 50 is mounted only on the top and/or bottom of a license plate. Otherwise, it is made in the same manner as a license plate frame, e.g., with a wide variety of materials, manufacturing processes, and material colors and finishes, but at reduced material and manufacturing costs due to the reduced plate area coverage and increased simplicity of its design.

When installed, the accent bar 50 functions to increase the structural integrity of the license plate mounting bracket of a vehicle by facilitating securing a license plate within the bracket. To this end, the accent bar 50 has mounting loops 52 and 54 for mounting the accent bar 50 in front of a vehicle license plate (not shown) on a standard license plate mounting bracket. The mounting loops 52, 54 extend transversely to the elongated structural member 51 and are spaced apart a distance measured from the center of the loops 52, 54 along an axis of the member 51. The loop center separation distance preferably being selected to match standard license plate mounting holes and standard vehicle license plate mounting brackets, e.g., approximately 8-inch separation distance for automobiles in the United States. To provide proper installation, the elongated structural member 51 preferably has a length at least slightly longer than the loop center separation distance, although the loops 52, 54 can be positioned at the ends of the elongate member 51 to reduce the length of member 51. Also, instead of loops 52, 54, mounting holes may be provided in the elongated structural member 51.

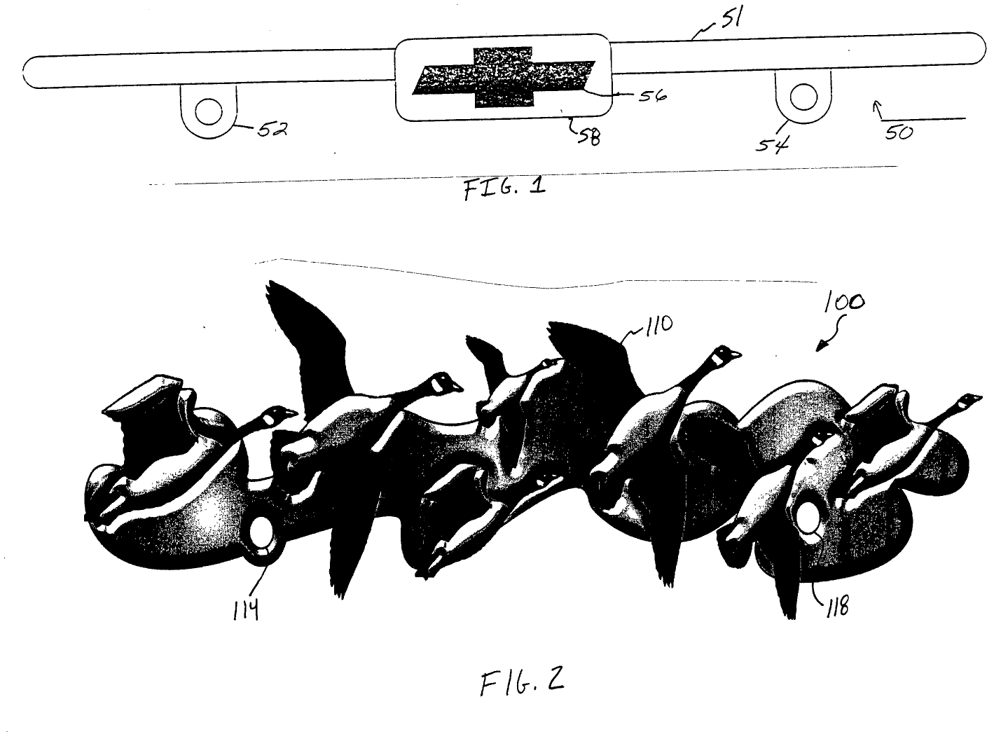

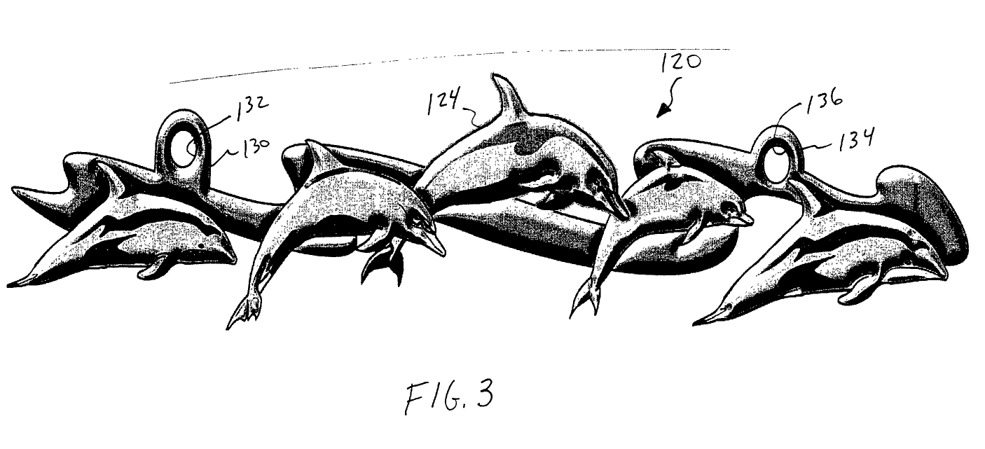

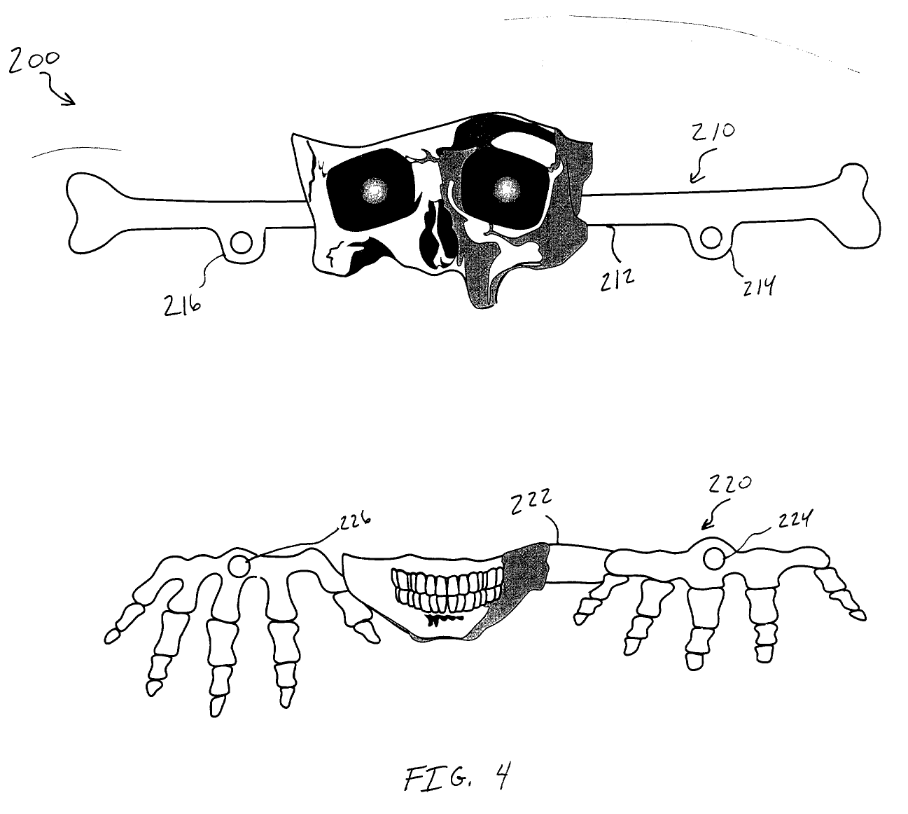

According to an important aspect of the invention, the accent bars of the invention including bar 50 function to allow personalizing or accenting messages or graphics to be displayed on and around a standard vehicle license plate. In this regard, additional accent elements may be included, such as by attachment to the elongate member 51, or by forming the elongate structural member to include an integral accent element. The integration of the elongate structural member with the accent member is often useful for reducing manufacturing costs, increasing the service life of the accent bar, for allowing the accent bar to fit in smaller spaces as may be required with many vehicles, and for providing other benefits. As shown in FIG. 2, a logo element 56 on plate 58 is included in the accent bar 50 and is attached to the elongate member 51. Although attached mechanically in this embodiment as shown in FIG. 4, the logo element 56 and/or plate 58 can readily be formed with the elongate member 51 as a one-piece construction. In the accent bar 50, the logo element 56 and plate 58 together can be thought of as the accent element that is included in the accent bar 50.

In some other preferred embodiments, the logo 56 or a trademark member (such as trademark 40) is not provided with the accent bar 50. Instead, the accent bar 50 utilizes the elongate member 51 itself as the accent element. In other words, the elongate structural member 51 may be used as shown in FIG. 2 (such as without the logo element 56 and with or without the holes 66 shown in FIG. 4) to accent a license plate or may be shaped, textured, and/or colored to provide the dual function structural and displaying functions.

FIG. 2 illustrates one embodiment of the invention in which the structural and display or accenting functions are combined or integrated. As shown, an accent bar 100 is provided with an elongate structural member 110 with mounting holes 114, 118 (instead of mounting loops 52, 54 as shown in FIG. 2) for allowing the accent bar 100 to be mounted with typical fasteners, such as screws or bolts, over a top or bottom portion of a license plate to secure the license plate within the mounting bracket. In the accent bar 100, the elongate member 110 includes the accent element or elements as it is shaped as geese flying in clouds when viewed from the front, i.e., the side of the elongate member 110 that would be exposed when the bar 100 is mounted on a vehicle. The elongate member 110 may be colored or textured to enhance the display or frontal shape selected (such as by coloring the geese or dolphins or other shapes or letters) and made of many useful materials, such as plastic, metal, and the like.

The particular shape of the elongate member 110 is not limiting to the invention and may be any shape desired by vehicle operators and may include text or be text only (with the elongate member 110 being formed of letters). The amount the elongate member 110 or its integral or added accent element extends outside the license plate edges is preferably selected to suit particular vehicle designs, i.e., with little extension for vehicles that have obstructions near the mounting location of the license plate. For example, the accent bar 100 of FIG. 2 is designed to be mounted at the upper portion of a license mounting bracket. FIG. 3 illustrates another accent bar 120 with an elongate member 124 having an integrated accent element providing a graphic message or image of dolphins swimming in waves. The accent bar 120 is configured for mounting on the lower portion of a license mounting bracket with mounting loops 130, 134 having holes 132, 136, respectively, for receiving mounting fasteners (not shown).

The elongate members 110, 124 are illustrated with the accent members (e.g., the flying geese and swimming dolphins) being integral in one-piece fabricated parts. In other embodiments, the accent member may be a separately fabricated part, such as a relatively flat accent plate, that is attached to the elongate member, such as an elongate structural member with the shape of member 51 of FIG. 1. In other words, the invention is not limited to the accent element and the elongate member being integrally formed (see logo member 56 and plate 58 for an example of separately formed accent elements).

While the accent bar 100 can be positioned on the top or the bottom portion of a license plate, an accent assembly can be provided that uses an upper and a lower accent bar to secure the upper and lower portion of the license plate within a mounting bracket and to provide an upper and lower display or accent area for creating a single textual or graphic display. One such accent assembly 200 is shown in FIG. 4. An upper accent bar 210 is provided for mounting on the upper portion of a license to secure the plate within a standard mounting bracket with fasteners passed through mounting loops 214, 216. The loops 214, 216 extend downward from elongated structural member 212. The structural member 212 is formed with integral accent elements, e.g., a top half of a desired graphical or textual message such as the upper half of a graphical skeleton display. As discussed above, the accent elements can also be formed separately and later rigidly attached to the elongate structural member 212.

A lower accent bar 220 is also included in the accent assembly 200 to mechanically secure the lower portion of the license plate and to also provide a second, lower display area that allows completion or continuation of the display or accent provided by upper accent bar 210. As shown, the lower accent bar 220 includes an elongate structural member 222 with mounting holes 224, 226 spaced apart a standard separation distance for mounting the lower a accent bar 220 within a standard license plate mounting bracket with fasteners (and with a hole-center separation distance from the upper mounting loops 214, 216, or holes in the loops, matching the vehicle mounting bracket which is about 4.75 inches in the United States). Accent elements (such as the skeletal fingers and teeth) are provided integrally with the elongated structural member 222 to provide a display area on the accent bar 220. In the illustrated embodiment, the accent elements may be formed as part of the structural member 222 as a one-piece part. In other embodiments of the lower accent bar 220, the accent elements are formed separately and rigidly attached to an elongate structural member (such as a member with the shape of member 51 of accent bar 50 in FIG. 2). Note, even with the use of two accent bars, the accent bars 210, 220 do not join on the sides and typically do not extend along the sides of the license plate which reduces the amount of materials required and which creates a significantly different display area shape and accenting effect.

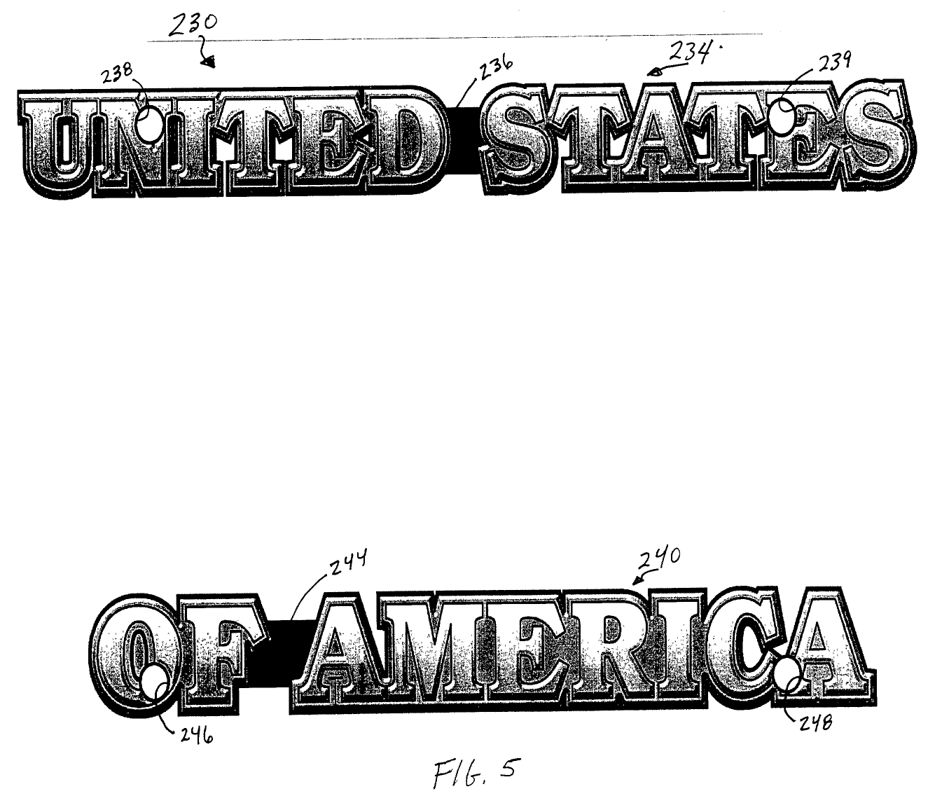

While shown using graphic shapes for the accent elements on or of the elongate structural members 212, 222, the accent elements may include or fully comprise text elements to allow a message to be displayed on the upper and/or lower portion of a license plate. One accent assembly 230 is shown in FIG. 5 that includes an upper accent bar 234 and a lower accent bar 240 with elongate members 236 and 244, respectively, that include textual accent elements (i.e., “UNITED STATES” and “OF AMERICA”). Mounting holes 238, 239, 246, and 248 are provided in the upper and lower elongate members 236, 244 to facilitate mounting of the accent assembly 230 on the upper and lower portions of a license plate mounting bracket to secure a license plate within the bracket and to display the text message provided by the accent elements. In other embodiments, textual accent elements are combined with graphical accent elements on the upper, lower, and/or both the upper and lower accent bars.

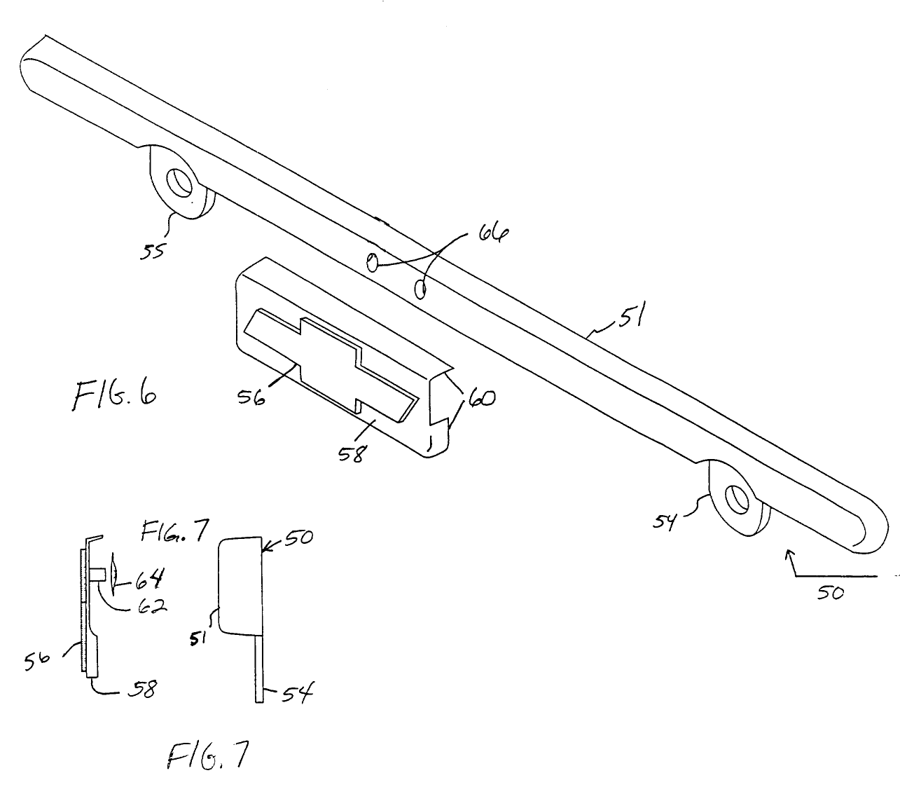

FIG. 6 is a top, front, right side perspective view of an embodiment of an accent bar 50 as the customizing logo member 56 and plate 58 are about to be installed. The logo member 56 is mounted on the plate 58 having a skirt 60, which matches the profile of the elongate structural member 51 to facilitate installation. By matching the profile, the skirt 60 restricts the ability of the logo plate 58 to rotate on the member 51 and also dresses up the resulting combination so that the assembled accent bar 50 looks like a unitary product. On the back of the plate 58 are two pins 62 similar to pins 41 and 43 of FIG. 3. See also FIG. 7.

FIG. 7 is a right side elevation view of FIG. 6. The bar 50 has thin mounting loops 54, 55 for attachment by bolts or fasteners to a license plate holder (not shown) on a vehicle. One of the two pins 62 on the back to the plate 58 holding the logo 56 is shown. The bar 50 has two holes 66 for attaching the logo 56 and plate 58. The logo plate 58 is secured to the bar 50 by pushing one pin 62 into the hole 66 along with the second pin 62, which cannot be seen into a second hole 66. After the pins 62 are pushed into the holes 66, metal retainers 64 are pushed over the pins 62 to secure them into place. It is noted in FIG. 5 that the pins 62 are shorter than the thickness of the bar 50 shown to the right. This is possible because bar 50 is not solid but is instead hollowed out in the back in a manner well known in the art. As discussed previously, the elongate member 51 without the plate 58 may be considered a complete accent bar 50 with member 51 having an integrated accent element (i.e., the shape, color, and texture of member 51) and be mounted on a mounting bracket. In other embodiments, the logo 56 and plate 58 (e.g., an accent element) can be integrally formed with member 51 or be mounted without the use of holes 66, pins 62, and retainers 64.

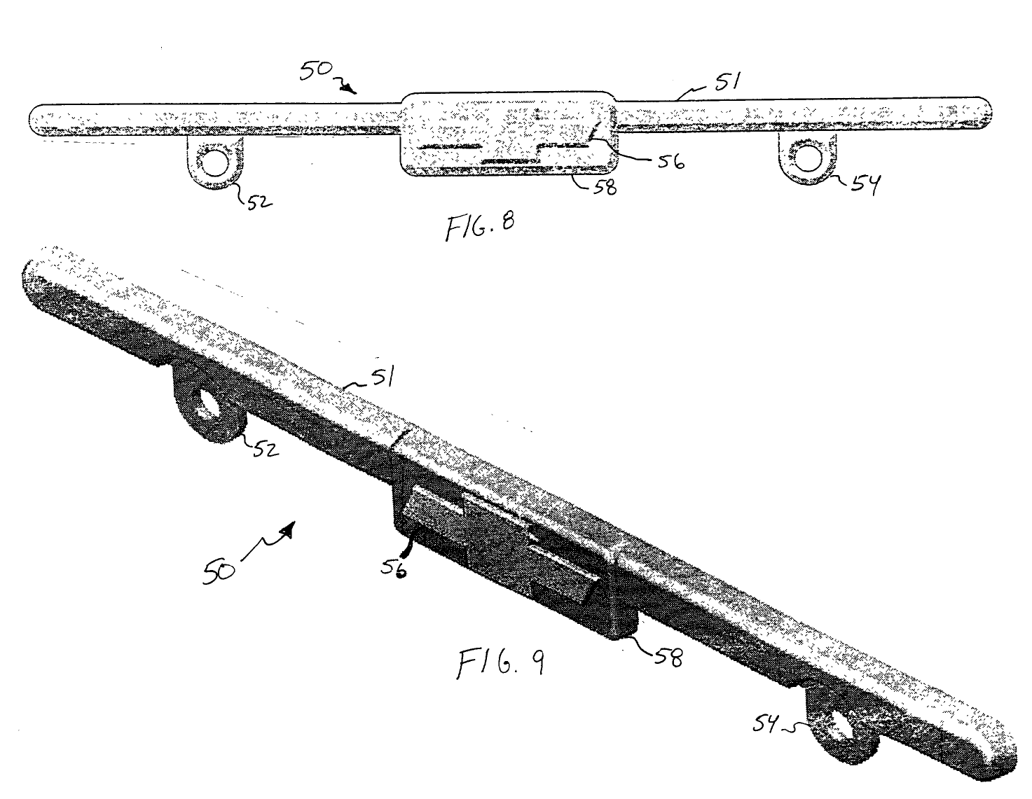

FIG. 8 is another front elevation view of the accent bar 50 of FIG. 1.

FIG. 9 is a top, front, right side perspective view of the accent bar 50 of FIG. 1.

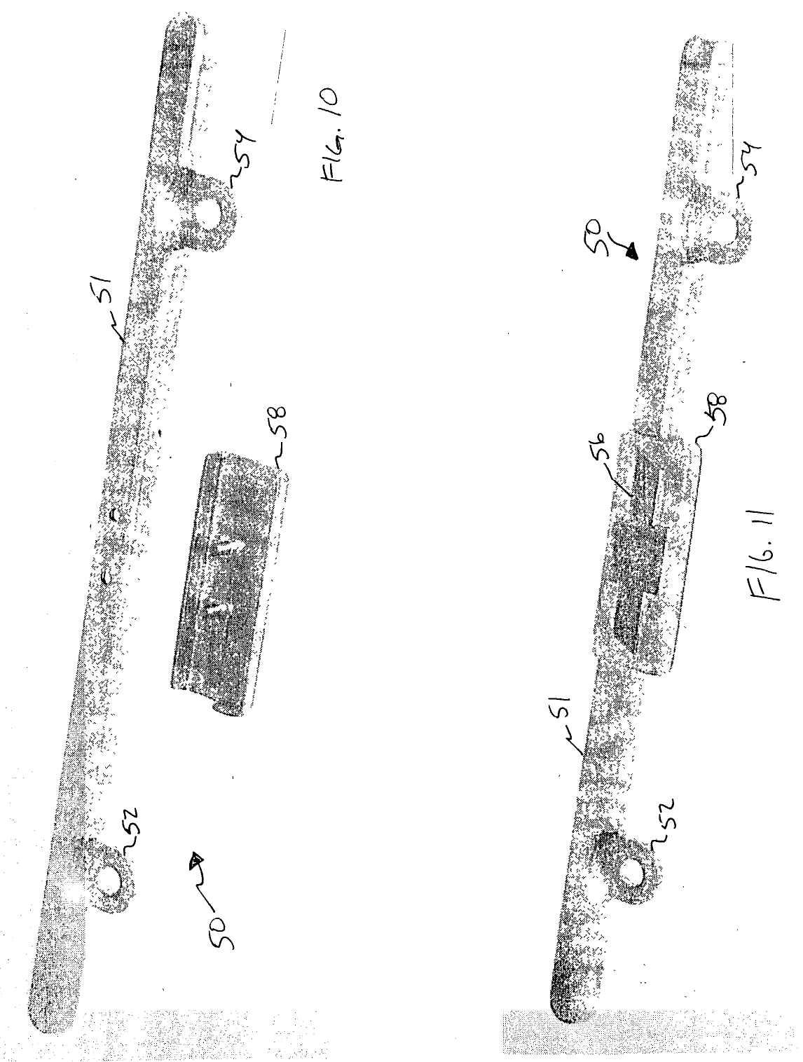

FIG. 10 is a top, front, right side perspective view of the accent bar 50.

FIG. 11 is a top, front, right side perspective view of the accent bar 50 similar to FIG. 10 prior to installation of the customizing logo 56 and plate 58 (e.g., an accent element), which in some preferred embodiments is integrally formed with elongate member 51 or mounted with techniques known in the mechanical arts other than with pins and retainers.

By providing standardized frames and accent bars, the dealers who stock these items need to have only one style of each instead of dozens of different styles. Of course, more than one material or color could be stocked. For example, brass, steel, white, and black colors in metal and plastic have been found to create desirable appearances. Others are also possible such as green and red colored of metal or plastic for special occasions. The customer then selects the logo or trademark they want to customize their frame or accent bar. Hundreds of logos, trademarks, designs, and short phrases can be made available at low cost for this purpose. The dealer is thereby able to offer a much wider selection than would be possible if he had to stock completed frames, which might never sell.

The preferred embodiments of the invention described herein are exemplary and numerous modifications, dimensional variations, and rearrangements can be readily envisioned to achieve an equivalent result, all of which are intended to be embraced within the scope of the appended claims.

What is claimed is:

1. An apparatus for securing a vehicle license plate to a plate mounting bracket and for providing an accent display area on an upper portion, a lower portion, or upper and lower portions of the license plate without extending continuously around the periphery of the vehicle license plate, comprising:
an elongated structural member having a length of at least about a distance between pairs of upper or lower mounting holes on the vehicle license plate;
means for receiving and contacting a pair of fasteners passed through the mounting holes used to secure the elongated structural member against the upper or the lower portion of the license plate and to the plate mounting bracket; and
an accent element comprising a display surface on the elongated structural member for displaying an accenting message on the upper or the lower portion of the license plate.

2. The apparatus of claim 1, wherein the accent element and the elongated structural member are integral.

3. The apparatus of claim 2, wherein the accent element and the elongated structural member are formed of like material.

4. The apparatus of claim 1, wherein the accenting message is a textual phrase and the display surface includes text.

5. The apparatus of claim 1, wherein the accenting message is graphical design and the display surface includes a shape of an object.

6. The apparatus of claim 1, wherein the receiving and contacting means comprises a pair of holes in the elongated structural member spaced apart similarly to the mounting holes.

7. The apparatus of claim 1, wherein the receiving and contacting means comprises a pair of mounting loops extending from a side of the elongated structural member spaced apart similarly to the mounting holes on the vehicle license plate.

8. An accenting assembly for use in mounting a vehicle license plate to a vehicle and for accenting an upper and lower portion of the license plate, comprising:
an upper accent bar including an elongate structural member with a pair of holes spaced apart a distance corresponding to a spacing of mounting holes on the license plate for receiving fasteners to secure the upper accent bar against the upper portion of the license plate and rigidly attach the license plate to a vehicle mounting bracket; and
a lower accent bar including an elongate structural member with a pair of holes spaced apart the mounting holes distance for receiving fasteners to secure the lower accent bar against the lower portion of the license plate and rigidly attach the license plate to the vehicle mounting bracket.

9. The accenting assembly of claim 8, wherein the upper accent bar includes a first accent element and the lower accent bar includes a second accent element, the first and second accent elements being a first and second portion of a textual or graphical display.

10. The accenting assembly of claim 8, wherein the upper accent bar includes an accent element integrally formed with the elongate structural member of the upper accent bar.

11. The accenting assembly of claim 10, wherein the accent element includes a shape of an object.

12. The accenting assembly of claim 8, wherein the lower accent bar includes an accent element integrally formed with the elongate structural member of the lower accent bar.

13. The accenting assembly of claim 12, wherein the accent element includes a shape of an object.
